(19) United States
(12) Patent Application Publication
(10) Pub. No.: US 2013/0044499 A1
(43) Pub. Date: Feb. 21, 2013

(54) METHOD FOR COATING LIGHT EMITTING WINDOW FOR PLASMA LIGHTING LAMP AND LIGHT EMITTING WINDOW FOR PLASMA LIGHTING LAMP MANUFACTURED USING THE SAME

(71) Applicant: Beum Ku Park, Guri-si (KR)

(72) Inventor: Beum Ku Park, Guri-si (KR)

(21) Appl. No.: 13/695,192

(22) PCT Filed: Apr. 28, 2011
(86) PCT No.: PCT/KR11/03152

§ 371 Date: Oct. 29, 2012

(30) Foreign Application Priority Data
Apr. 29, 2010 (KR) 10-2010-0039840

(51) Int. Cl. F21V 9/10; B05D 5/06

(52) U.S. Cl. 362/351; 427/160

(57) ABSTRACT

Disclosed is a method for coating a light emitting window for a plasma lighting lamp and a light emitting window for a plasma lighting lamp manufactured using the same which make it possible to prevent electromagnetic waves generating from the microwave wavelength of the magnetron from discharging to the outside when using a non-electrode plasma lighting lamp while cutting off the wavelengths of a frequency used in a wireless communication, and the color lights transmitting through the invisible window has uniform colors. The method for coating a light emitting window for a plasma lighting lamp comprises a first step for forming a thin nano-coating later 21 by coating a nano-material on a surface of a light emitting window 20; and a second step for forming a color filter coating layer 22 by coating a dielectric material on an upper surface of the nano-coating layer 21 so that only a wavelength among the wavelengths of a visible light can transmit, and in the second step, the color filter coating layer 22 is coated with different thicknesses depending on the luminance obtained by the emission of a plasma, by the sections as formed by dividing the light emitting window 20 into a plurality of sections.

### BACKGROUND OF THE INVENTION

The present invention relates to a method for coating a light emitting window for a plasma lighting lamp and a light emitting window for a plasma lighting lamp manufactured using the same which feature in that the surface of a light emitting window for a lighting lamp is nano-coated when manufacturing a light emitting window for a plasma lighting lamp used for lighting a billboard or a status or a building with a certain color light, and the coating thickness of the color filter coating layer is made different by the positions, thus emitting uniform colors lights over the whole surfaces of the light emitting window.

A lighting lamp is generally used in order for various structures such as a billboard, a status or a building to be easily recognized at nights. The conventional lighting lamp is configured to emit light based on electrodes. In recent years, a non-electrode light source and a lighting means emitting various color lights using a reinforced glass window having a color filter coating layer are widely used so as to emphasize the natures of a structure or a design feature of it. As an example, as shown in FIGS. 1 to 3, a plasma lighting system (PLS) is generally used.

As shown in FIGS. 1 and 2, the non-electrode lighting lamp 10 features in that a specific gas is filled in an invisible bulb 15 provided in the interior of a body 11, and as a microwave is applied to the invisible bulb 15 from a magnetron 13 connected with the invisible bulb 15, the gas filled in the invisible bulb 15 is intensively ionized, namely, becomes a plasma state, thus emitting light as the electrons of a specific gas are emitted.

At this time, the emitting light passes through the light emitting window 20 having a color filter coating layer and is converted into a color light 30 having a specific color depending on the thickness of the color filter coating layer, and as shown in FIG. 3, the color light 30 lights various structures 40 such as a billboard, a status or a building.

As shown in FIG. 2, when the light from the bulb 15 reaches the light emitting window 20, the luminance is different depending on the positions of the light emitting window 20, so the color lights 30 have different colors by the positions on the whole areas where the color lights 30 emit to, so the color lights emitting to the whole surfaces of the structure 40 are not uniform.

### SUMMARY OF THE INVENTION

Accordingly, the present invention is made to improve the above explained problems. It is an object of the present invention to provide a method for coating a light emitting window for a plasma lighting lamp and a light emitting window for a plasma lighting lamp manufactured using the same which make it possible to prevent electromagnetic waves generating from the microwave wavelength of the magnetron from discharging to the outside when using a non-electrode plasma lighting lamp while cutting off the wavelengths of a frequency used in a wireless communication, and the color lights transmitting through the invisible window has uniform colors.

To achieve the above objects, there is provided a method for coating a light emitting window for a plasma lighting lamp, comprising a first step for forming a thin nano-coating later 21 by coating a nano-material on a surface of a light emitting window 20; and a second step for forming a color filter coating layer 22 by coating a dielectric material on an upper surface of the nano-coating layer 21 so that only a wavelength among the wavelengths of a visible light can transmit, and in the second step, the color filter coating layer 22 is coated with different thicknesses depending on the luminance obtained by the emission of a plasma, by the sections as formed by dividing the light emitting window 20 into a plurality of sections.

To achieve the above objects, there is provided a light emitting window for a plasma lighting wherein the light emitting window 20 comprises a nano-coating layer 21 formed as a nano-coating material is coated on a surface of the light emitting window 20; and a color filter coating layer 22 formed in such a way that a dielectric material is coated on a surface of the nano-coating layer for only a wavelength of a region among the wavelengths of a visible ray to transmit, and the color filter coating layer 22 is formed with different thicknesses by the sections depending on the luminance by the emission of a plasma as it is divided into a plurality of sections.

In the first step, the nano-material selected from the group consisting of liquefied Ag and SnO₂ is coated in a spin or spray method and then is heat-treated.

In the second step, a dielectric material selected from the group consisting of Ta2O₅, SiO₂ and TiO₂ is coated under a vacuum of below 3×10⁵ tore at a temperature of above 250° C.

### BRIEF DESCRIPTION OF DRAWINGS

FIG. 1 is a perspective view illustrating a plasma lighting lamp.

FIG. 2 is a cross sectional view illustrating a light emitting principle of a plasma lighting lamp.

FIG. 3 is a concept view illustrating a lighting principle of a plasma lighting lamp.

FIG. 4 is a front view illustrating a coating method of a light emitting window for a lighting lamp according to an embodiment of the present invention.

FIG. 5 is a cross sectional view illustrating a light emitting window for a lighting lamp which is taken by cutting away along the line A-A of FIG. 4.

FIG. 6 is a front view illustrating a coating method of a light emitting window for a lighting lamp according to another embodiment of the present invention.

### DETAILED DESCRIPTION OF THE INVENTION

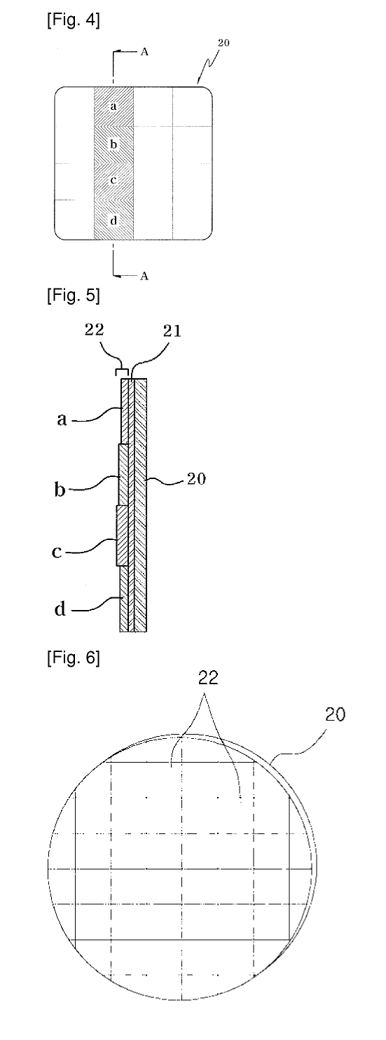

The preferred embodiments of the present invention will be described with reference to FIGS. 4 and 5. The disclosed embodiments of the present invention are provided for the illustrative purposes, not intending to limit the scope of the present invention. The technologies which are obvious to an ordinary person skilled in the art or which can be easily anticipated by those skilled in the art will be omitted from descriptions.

FIG. 4 is a front view illustrating a coating method of a light emitting window for a lighting lamp according to an embodiment of the present invention. FIG. 5 is a cross sectional view illustrating a light emitting window for a lighting lamp which is taken by cutting away along the line A-A of FIG. 4.

As shown in FIGS. 4 and 5, the light emitting window 20 installed at a front side of the plasma lighting lamp is made from an invisible reinforced glass which withstands a high temperature, and a nano-coating layer 21 coated with a nano-material is formed on the surface of the light emitting window 20, and a color filter coating layer 22 is formed on the surface of the nano-coating layer 21 of the light emitting window 20.

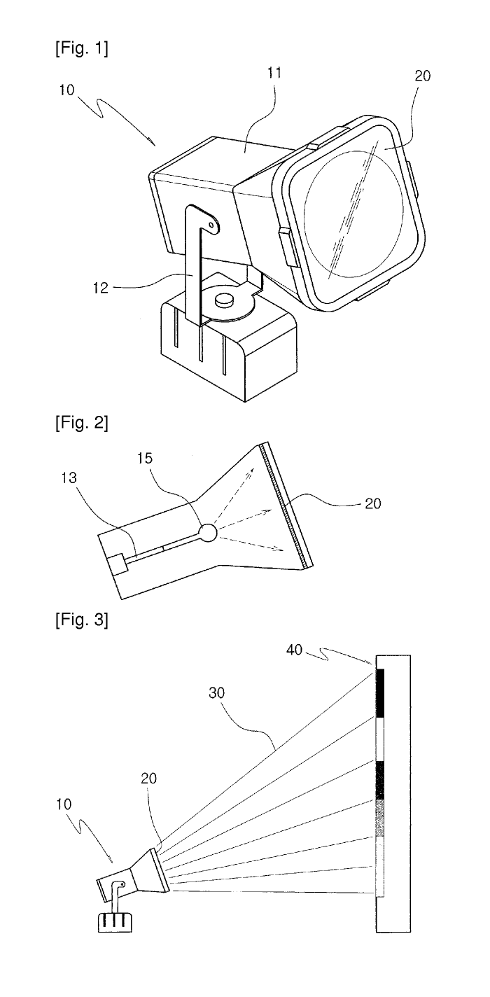

At this time, the color filter coating layer 2 is coated with a dielectric material so that a light having a certain wavelength of the wavelengths (about 400-700 nm) of a visible light on the spectrum as shown in FIG. 1 can transmit. For example, if a color having a wavelength of 700 nm is coated on the color filter coating layer 22, a color light 30 (FIG. 3) of which only the red component transmits is reflected on a structure while showing an image thereon, and if a color having a wavelength of 550 nm is coated, only the red component transmit.

At this time, the color filter coating layer 22 is coated (FIG. 5) with different thicknesses at each section formed as the surface of the light emitting window 20 is sectioned into multiple sections (FIG. 4). When the light generating from the plasma in the bulb 15 as shown in FIG. 2 is emitted to the light emitting window 20, only the visible lights having the same colors transmit through the whole regions of the invisible window 20 irrespective of luminance. The manufacture of the light emitting window 20 for the lighting lamp will be described hereinafter.

The coating method of a light emitting window for a plasma lighting lamp according to the present invention comprises a first step for forming a nano-coating layer 21 which is made thin by coating a nano-material on the surface of the light emitting window 20, and a second step for forming a color filter coating layer 22 in such a way to coat a dielectric material on the upper surface of the nano-coating layer 21 so that only a certain wavelength among the wavelengths of a visible light can transmit.

The nano-material in the nano-coating layer 21 in the first step is a nano-material produced by liquefying Ag or SnO₂. and it is coated by coating the thusly produced nano-material in a spin or a spray method and then performing a heat treatment.

The spin coating is directed to making the whole structure thinner in such a way to coating a liquid nano-material on the center of the light emitting window 20 and rotating it at above 3000 rpm and drying it. Thanks to the use of the centrifugal force, the nano-material can be uniformly spread on the whole surfaces of the light emitting window.

The spray coating is directed to coating by spraying a nano-material liquid at a high speed using a nozzle on the light emitting window 20. The heat treatment is directed to solidifying the coated nano-material on the light emitting window 2. Since the above mentioned process is known, the descriptions thereof will be omitted.

It is checked whether the surface resistance of the nano-coating layer 21 is smaller than 12 Ohm using the resistance meter and it is also checked whether the thin film strength or the adhering force meets the standards.

The thusly formed nano-coating layer 21 can cut off the harmful electromagnetic waves which generate from the microwave lengths and the wavelengths of the frequency used for a wireless communication.

The dielectric material contained in the color filter coating layer 22 of the second step is selected from the group consisting of Ta2O₅, SiO₂, and TiO₂ and is vacuum-deposited in the vacuum deposition unit. The vacuum deposition is performed in such a way that a light emitting window 20 coated with a nano-coating layer 21 is engaged in the chamber with a vacuum environment, and electron beams or the like are emitted to the dielectric material, and the dielectric material is heated and vaporizes. The vaporizing gas makes the nano-coating layer 21 of the light emitting window 20 be attached. It is preferred that the deposition is performed under the vacuum environment of 3×10⁻⁵ torr at a temperature of 250° C.

It is preferred that the color filter coating layer is coated with different thicknesses by the sections formed by dividing the light emitting window 20 into multiple sections. The thicknesses of the color filter coating layer 2 can be made different by adjusting the vacuum deposition time under the same vacuum deposition environment.

As shown in FIG. 4, the light emitting window 20 is sectioned into a plurality of sections, and the luminance is measured by the sections depending on the plasma lighting. In other words, the luminance of each of the sections “a, b, c and d) is measured, and the thickness of the color filter coating layer of each section is calculated to make sure that each section transmits the colors of the same visible lights, and a corresponding section is vacuum-deposited by the sections.

More sections might be formed for details or fewer sections might be formed than the sections shown in the drawings, and only the selected section might be deposited and the remaining sections might be used as the cutoff film so as to prevent the deposition.

As shown in FIG. 5, the color filter coating later 22 of which the thicknesses are different by the sections are formed in the above explained manner, so the color lights having the same wavelengths can be emitted from the whole surfaces of the light emitting window 20.

FIG. 6 is a front view illustrating a coating method of a light emitting window for a lighting lamp according to another embodiment of the present invention.

The light emitting window 20 of FIG. 4 has been described assuming that it is formed in a rectangular shape when viewing from the front side of it; however as shown in FIG. 6, it might be manufactured in a circular shape.

In the circular light emitting window 20, the color filter coating layer 22 might be configured to have different thicknesses depending on the luminance by forming the lattice shaped sections, the detailed descriptions will be omitted because they were explained earlier.

The above descriptions are provided in relation with the preferred embodiments of the present invention; however it is obvious that an ordinary person skilled in the art could modify or change without escaping from the concept and scope of the present invention, and such modifications and changes belong to the scopes of the claims of the present invention.

According to the present invention, the nano-coating layer formed at an inner surface of the light emitting window prevents the harmful electromagnetic waves, which generate from the micro wavelengths of the magnetron 13, from being discharged to the outside while preventing the wavelengths of the frequencies used in the wireless communication from being inputted into the interior, so the microwaves can be emitted in safe.

The color filter coating layer formed on an inner surface of the light emitting window is coated with different thicknesses by the positions in consideration of the luminance, so the color lights passing through the light emitting window 20 have uniform colors on the whole portions, so the color of the light reflected on a certain structure can have one color pattern in the whole regions so as to make sure that the visibility of the structure can be enhanced, and the structure might look more valued than before.

1. A method for coating a light emitting window for a plasma lighting lamp, comprising:
a first step for forming a thin nano-coating later (21) by coating a nano-material on a surface of a light emitting window (20); and
a second step for forming a color filter coating layer (22) by coating a dielectric material on an upper surface of the nano-coating layer (21) so that only a wavelength among the wavelengths of a visible light can transmit, and in the second step, the color filter coating layer (22) is coated with different thicknesses depending on the luminance obtained by the emission of a plasma, by the sections as formed by dividing the light emitting window (20) into a plurality of sections.

2. A method for coating a light emitting window for a plasma lighting lamp according to claim 1, wherein in the first step, the nano-material selected from the group consisting of liquefied Ag and SnO₂ is coated in a spin or spray method and then is heat-treated.

3. A method for coating a light emitting window for a plasma lighting lamp according to claim 1, wherein in the second step, a dielectric material selected from the group consisting of Ta2O₅, SiO₂ and TiO₂ is coated under a vacuum of below 3×10⁵ tore at a temperature of above 250° C.

4. A light emitting window for a plasma lighting lamp manufactured by a method for coating a light emitting window for a plasma lighting lamp of claim 1 and the light emitting window (20) comprises:
a nano-coating layer (21) formed as a nano-coating material is coated on a surface of the light emitting window (20); and
a color filter coating layer (22) formed in such a way that a dielectric material is coated on a surface of the nano-coating layer for only a wavelength of a region among the wavelengths of a visible ray to transmit, and the color filter coating layer (22) is formed with different thicknesses by the sections depending on the luminance by the emission of a plasma as it is divided into a plurality of sections.

5. A light emitting window for a plasma lighting lamp manufactured by a method for coating a light emitting window for a plasma lighting lamp of claim 2, and the light emitting window (20) comprises:
a nano-coating layer (21) formed as a nano-coating material is coated on a surface of the light emitting window (20); and
a color filter coating layer (22) formed in such a way that a dielectric material is coated on a surface of the nano-coating layer for only a wavelength of a region among the wavelengths of a visible ray to transmit, and the color filter coating layer (22) is formed with different thicknesses by the sections depending on the luminance by the emission of a plasma as it is divided into a plurality of sections.

6. A light emitting window for a plasma lighting lamp manufactured by a method for coating a light emitting window for a plasma lighting lamp of claim 3, and the light emitting window (20) comprises:
a nano-coating layer (21) formed as a nano-coating material is coated on a surface of the light emitting window (20); and
a color filter coating layer (22) formed in such a way that a dielectric material is coated on a surface of the nano-coating layer for only a wavelength of a region among the wavelengths of a visible ray to transmit, and the color filter coating layer (22) is formed with different thicknesses by the sections depending on the luminance by the emission of a plasma as it is divided into a plurality of sections.
